(19) United States
(12) Patent Application Publication
(10) Pub. No.: US 2002/0150737 A1
(43) Pub. Date: Oct. 17, 2002

(54) Water-discoloring printed matter and water-discoloring toy employing the same

(75) Inventor: Akio Nakashima, Nagoya-shi (JP)

Correspondence Address: SUGHRUE MION, PLLC, 2100 PENNSYLVANIA AVENUE, N.W., WASHINGTON, DC, 20037, US

(73) Assignee: THE PILOT INK CO., LTD.

(21) Appl. No.: 10/118,892

(22) Filed: Apr. 10, 2002

(30) Foreign Application Priority Data
Apr. 13, 2001 (JP) P. 2001-115343
Feb. 28, 2002 (JP) P. 2002-053651

(51) Int. Cl. B32B 3/00

(52) U.S. Cl. 428/195; 428/207

(57) ABSTRACT

A water-discoloring printed matter 1 which comprises a substrate having porous designs 3 closely formed on a surface of the substrate by scatteringly fixing at least one low-refractive-index pigment to the surface together with a binder resin; and a water-discoloring toy, e.g., a doll garment or stuffed toy, produced by sewing the printed matter in which the substrate is a fabric. The matter which in a dry state has a complicated, colorful, highly decorative appearance and produces a satisfactory discoloration effect upon water absorption; and a water-discoloring toy employing the same, such as a doll garment or stuffed toy.

### FIELD OF THE INVENTION

The present invention relates to a water-discoloring printed matter and a water-discoloring toy employing the same. More particularly, the invention relates to a water-discoloring printed matter which comes to have a different appearance upon adhesion of water thereto, and to a water-discoloring toy employing the printed matter.

### BACKGROUND OF THE INVENTION

A paper which assumes a color upon writing with water is disclosed as a printed matter coming to have a different appearance upon adhesion of water thereto (see Japanese Patent Publication No. 50-5097). This related-art color-assuming paper comprises a substrate and a porous layer formed thereon by scatteringly fixing a low-refractive-index pigment together with a binder resin.

On that paper assuming a color upon writing with water, a desired character or design can be drawn by writing with, e.g., a writing brush soaked with water.

### SUMMARY OF THE INVENTION

The paper assuming a color upon writing with water is suitable for writing applications, because the porous layer only is seen when the paper is in a dry state. However, in the field of toys and the like, the color-assuming paper has poor decorative properties because the color tone of the porous layer only is seen when the paper is in a dry state.

An aim of the invention is to provide a water-discoloring printed matter having excellent decorative properties. The invention provides a water-discoloring printed matter which comprises (1) a substrate and (2) closely-formed porous designs or patterns fixed on a surface of said substrate, said porous designs or patterns comprising a binder resin and a low-refractive-index pigment dispersed therein. Embodiments of the water-discoloring printed matter include the following: the printed matter wherein the porous designs or patterns are independent of one another; the printed matter wherein the porous designs or patterns are partly in contact with one another; the printed matter wherein the porous designs or patterns are linear; the printed matter wherein the porous patterns are selected from the group consisting of lattice patterns, net patterns, and knit patterns; the printed matter wherein the ratio of the area of the parts coated with the porous designs or patterns to the area of the parts not coated with the porous designs or patterns is from 30:70 to 95:5 per cm²; the printed matter wherein the substrate is a fabric; and the printed matter wherein the fabric is a stretchable knitted fabric. The invention further provides a water-discoloring toy which is in the form of a garment for dolls or of a stuffed toy and has been produced by sewing the printed matter.

### BRIEF DESCRIPTION OF THE DRAWINGS

FIG. 1 is a front view of one embodiment of the water-discoloring printed matter according to the invention.

FIG. 2 is an enlarged longitudinal sectional view illustrating the water-discoloring printed matter shown in FIG. 1.

FIG. 3 is a front view illustrating the water-discoloring printed matter of FIG. 1 to which water has been adhered.

FIG. 4 is a front view of another embodiment of the water-discoloring printed matter according to the invention.

FIG. 5 is an enlarged longitudinal sectional-view illustrating the water-discoloring printed matter shown in FIG. 4.

FIG. 6 is a front view illustrating the water-discoloring printed matter of FIG. 4 to which water has been adhered.

FIG. 7 is a front view of still another embodiment of the water-discoloring printed matter according to the invention.

FIG. 8 is a front view illustrating the water-discoloring printed matter of FIG. 7 to which water has been adhered.

In the figures, the numbers respectively have the following meanings.

1: water-discoloring printed matter

2: substrate

3: porous pattern

4: colored layer

5: porous design

### DETAILED DESCRIPTION OF THE INVENTION

The water-discoloring printed matter of the invention undergoes color changes by the following mechanism. When water is adhered to the porous designs or patterns and infiltrated thereinto, the designs or patterns become transparent or translucent. As a result, the printed matter comes to have a different appearance. When the water which has infiltrated into the porous designs or patterns vaporizes, the printed matter recovers the original state. Consequently, the water-discoloring printed matter can be practically used repeatedly.

Preferred as the medium used for discoloring the water-discoloring printed matter is water from the standpoints of easiness, safety, and cost. For the purpose of regulating the rate of drying to prolong the period in which an image can be seen, a water-soluble organic solvent such as, e.g., propylene glycol may be incorporated in a slight amount.

The water-discoloring printed matter is obtained by forming porous designs or patterns on a substrate by scatteringly fixing a low-refractive-index pigment thereto together with a binder resin. The designs or patterns have been closely arranged.

Consequently, when the printed matter is in a dry state, the parts not coated with the porous designs or patterns have a color tone which is different from the color tone of the porous designs or patterns. Namely, the color tone of the underlying substrate or of a colored layer formed on the substrate is seen. Because of this, the printed matter in a dry state has a complicated and colorful appearance and excellent decorative properties as compared with the printed matter having a porous layer over the whole substrate. Furthermore, because the water-discoloring printed matter has a surface with recesses and protrusions, it can be made to give a feeling of high quality.

The shape of the porous designs or patterns is not particularly limited.

The porous designs or patterns may be independent of one another, or may be partly in contact with one another.

Examples of the porous designs include circles, ellipses, polygons, e.g., triangles or hexagons, stars, and heart shapes, these designs being closely arranged to form a dot pattern.

Examples of the porous patterns include a checker pattern, honeycomb pattern, chain pattern, and various geometrical patterns each made up of rectangles closely arranged so as to be partly in contact with one another, and further include linear patterns.

Examples of the linear patterns include a lattice pattern, net pattern, and knit pattern each comprising a combination of lines.

Although the porous designs or patterns are closely arranged on the substrate, the degree of closeness is such that the ratio of the area of the porous designs or patterns to the area of the parts not coated with the porous designs or parts is preferably from 30:70 to 95:5, more preferably from 40:60 to 95:9, per cm².

When the areal ratio is within that range, both the decorative effect of the complicated colorful appearance of the printed matter in a dry state and the effect of discoloration of the porous designs or patterns by water absorption can be satisfied.

In case where the proportion of the parts not coated with the porous designs or patterns is too high, the effect of discoloration by water application cannot be sufficiently exhibited, resulting in an insufficient change in appearance.

In case where the proportion of the parts coated with the porous designs or patterns is too high, the color tone of the underlying layer is less apt to be seen when the printed matter is in a dry state. Hence, decorative properties are difficult to impart to the printed matter.

Examples of the material of the substrate include fabrics such as woven fabrics, knitted fabrics, braided fabrics, and nonwoven fabrics, synthetic papers, films, plastics, rubbers, artificial leathers, natural leathers, glasses, clayware, woods, and stones.

In the case where the printed matter employs a fabric as the substrate, it has the intact flexibility inherent in the fabric because the fabric has both parts coated with porous designs or patterns and parts not coated therewith. Consequently, this printed matter is suitable for use in applications such as personal articles made of fabric, clothing, garments for dolls, and skins of stuffed toys.

When a stretchable knitted fabric among those fabrics is used, stretchability can be imparted to the printed matter besides the flexibility inherent in fabrics. This printed matter is hence more suitable for use in clothing, garments for dolls, and skins of stuffed toys.

Examples of the stretchable knitted fabric include knitted fabrics formed by weft knitting, such as plain stitch, rib stitch, purl stitch, tuck stitch, lace stitch, float stitch, or plated stitch, and knitted fabrics formed by warp knitting, such as tricot stitch or denbigh stitch.

Even a poorly water-resistant material such as, e.g., wood-free paper, art paper, or coat paper can be made usable as a substrate by film laminating, resin coating or impregnation, or another method.

The shape of the substrate is preferably flat, but may be one having recesses and protrusions.

The constitution of the formation of porous designs or patterns on the substrate by scatteringly fixing a low-refractive-index pigment together with a binder resin will be explained below.

The porous designs or patterns are formed on the substrate by fixing a low-refractive-index pigment together with a binder resin in a dispersed condition.

Examples of the low-refractive-index pigment include finely particulate silicic acid, baryta powder, precipitated barium sulfate, barium carbonate, precipitated calcium carbonate, gypsum, clay, talc, alumina white, and basic magnesium carbonate. These substances each have a refractive index in the range of from 1.4 to 1.7 and come to have satisfactory transparency upon water absorption.

Although such low-refractive-index pigments are not particularly limited in particle diameter, it is preferred to use ones having a particle diameter of from 0.03 to 10.0 μm.

A combination of two or more of those low-refractive-index pigments can be used.

Preferred examples of the low-refractive-index pigment include finely particulate silicic acid. Finely particulate silicic acid is produced as noncrystalline amorphous silicic acid. According to production processes, the finely particulate silicic acid products are roughly classified into two groups, i.e., ones produced by a dry process in which a vapor-phase reaction such as, e.g., the pyrolysis of a silicon halide, e.g., silicon tetrachloride, is used (hereinafter referred to as dry-process finely particulate silicic acid) and ones produced by a wet process in which a liquid-phase reaction such as, e.g., the decomposition of, e.g., sodium silicate with an acid is used (hereinafter referred to as wet-process finely particulate silicic acid). Although either of the two finely particulate silicic acids can be used, wet-process silicic acid is preferred. This is because porous designs or patterns containing wet-process finely particulate silicic acid have higher hiding power in the ordinary state than ones containing dry-process finely particulate silicic acid, so that the proportion of the binder resin to the finely particulate silicic acid can be heightened and the film strength of the porous designs or patterns can be increased accordingly.

As stated above, the finely particulate silicic acid used for satisfying the ordinary-state hiding power of the porous designs or patterns preferably is wet-process finely particulate silicic acid. The reasons for the preference of wet-process silicic acid are as follows. Dry-process finely particulate silicic acid and wet-process finely particulate silicic acid differ in structure. Dry-process finely particulate silicic acid has the following three-dimensional structure constituted of densely bonded silicic acid molecules as shown below.

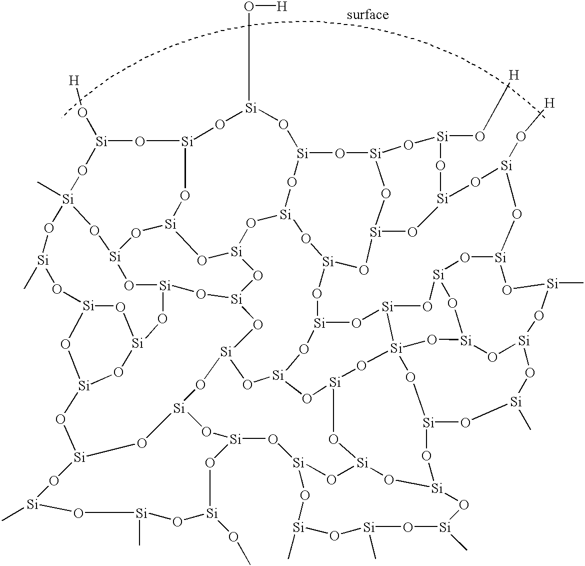

In contrast, wet-process finely particulate silicic acid has two-dimensional structure parts each comprising a long segment formed by the condensation of silicic acid molecules as shown below. Namely, wet-process finely particulate silicic acid has a sparser molecular structure than dry-process finely particulate silicic acid. It is presumed that, due to this difference in molecular structure, porous designs or patterns containing wet-process finely particulate silicic acid are excellent in irregular light reflection in a dry state and hence have higher hiding power in the ordinary state as compared with porous designs or patterns containing dry-process finely particulate silicic acid.

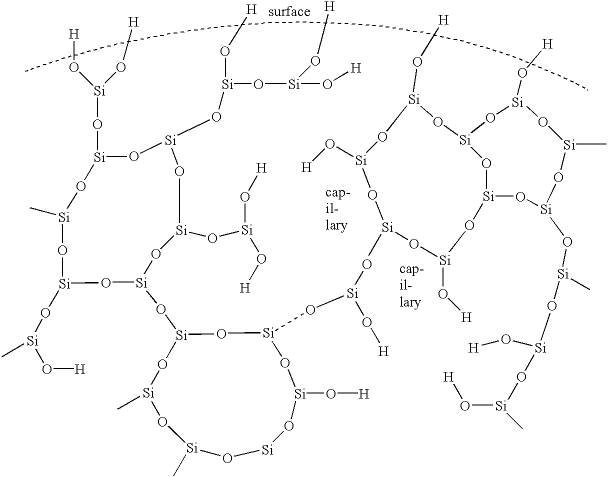

The low-refractive-index pigment contained in the porous designs or patterns desirably had moderate hydrophilicity because the medium to be infiltrated thereinto is mainly eater. Wet-process finely particulate silicic acid has a larger amount of hydroxyl groups present as silanol groups on the surface of the particles than dry-process finely particulate silicic acid. The former silicic acid hence has higher hydrophilicity and is preferred.

In the case where wet-process finely particulate silicic acid is used as the low-refractive-index pigment, the amount of the silicic acid to be applied is preferably from 1 to 30 g/m², more preferably from 5 to 20 g/m², from the standpoint of satisfying both ordinary-state hiding power and transparency in a water-wet state, although the amount thereof depends on the kind, particle diameter, specific surface area, oil absorption, and other properties of the wet-process finely particulate silicic acid. In case where the amount of the silicic acid is smaller than 1 g/m², it is difficult to obtain sufficient ordinary-state hiding power. In case where the amount thereof exceeds 30 g/m², it is difficult to obtain sufficient transparency in a water-wet state.

The low-refractive-index pigment is dispersed in a vehicle containing a binder resin as a binding agent. This dispersion is applied to a substrate and then dried to remove the volatile ingredient and thereby form porous designs or patterns.

Examples of the binder resin include urethane resins, nylon resins, vinyl acetate resins, acrylic ester resins, acrylic ester copolymer resins, acrylic polyol resins, vinyl chloride/vinyl acetate copolymer resins, maleic acid resins, polyester resins, styrene resins, styrene copolymer resins, polyethylene resins, polycarbonate resins, epoxy resins, styrene/butadiene copolymer resins, acrylonitrile/butadiene copolymer resins, methyl methacrylate/butadiene copolymer resins, butadiene resins, chloroprene resins, melamine resins, emulsions of these resins, casein, starch, cellulose derivatives, poly(vinyl alcohol), urea resins, phenolic resins, and epoxy resins.

The proportion of the binder resin to the colorant in the porous designs or patterns is lower than in general coating films which have been known hitherto. A sufficient film strength is hence difficult to obtain. Consequently, for use in applications where laundering resistance and abrasion resistance are required, it is preferred that the binder resin be a urethane resin or nylon resin or at least contain either of these resins.

Examples of the urethane resin include polyester urethane resins, polycarbonate urethane resins, and polyether urethane resins. Two or more of these resins may be used in combination. Also usable are a urethane resin emulsion which is an emulsion of any of these resins in water and a colloidal (ionomer type) urethane resin prepared by dissolving or dispersing an ionic urethane resin (urethane ionomer) by means of self-emulsification based on the ionic groups thereof without necessitating an emulsifying agent.

Although those urethane resins may be either water-based or oil-based urethane resins, it is preferred to use water-based urethane resins, especially urethane resin emulsions or colloidal urethane resins.

One or more of those urethane resins may be used as the only binder resin. However, they may be used in combination with one or more other binder resins according to the kind of the substrate and the performances required of the film. In the case where a urethane resin is used in combination with other binder resin(s), the content of the urethane resin in the porous designs or patterns is preferably 30% by weight or higher based on all binder resins on a solid basis from the standpoint of obtaining a practical film strength.

When a crosslinkable binder resin among the aforementioned ones is used, any desired crosslinking agent may be added to crosslink the resin. Thus, the film strength can be further improved.

Some of the binder resins mentioned above have a high affinity for the medium, while others have a low affinity therefor. By using a suitable combination of two or more of these, the porous designs or patterns can be regulated with respect to the time period required for the medium to infiltrate thereinto, the degree of infiltration, and the rate of drying after infiltration. Furthermore, a dispersant may be suitably added to control the infiltration performances.

A known metallic-luster pigment may be added to the porous designs or patterns. Examples of the pigment include a mica coated with titanium dioxide, mica coated with iron oxide and titanium dioxide, mica coated with iron oxide, guanine, sericite, basic lead carbonate, acid lead arsenate, and bismuth oxychloride. It is also possible to add general dyes or pigments. Thus, color changes can be diversified.

For forming the porous designs or patterns, known techniques can be used. Examples thereof include printing techniques such as screen printing, offset printing, gravure printing, coater printing, dabber printing, and transfer printing and coating techniques such as brush coating, spray coating, electrostatic coating, electrodeposition, curtain coating, roller coating, and dip coating.

A non-discoloring layer may be formed between the substrate and the porous designs or patterns using a non-discoloring ink containing a general dye or pigment or a fluorescent dye or pigment.

On the water-discoloring printed matter thus formed may be optionally formed a metallic glossy layer (image) by applying an ink containing a metallic-luster pigment such as, e.g., a mica coated with titanium dioxide, mica coated with iron oxide and titanium dioxide, mica coated with iron oxide, guanine, sericite, basic lead carbonate, acid lead arsenate, or bismuth oxychloride. Furthermore, a thermochromic layer (image) comprising a reversibly thermochromic composition which changes in color reversibly with temperature may be formed on the printed matter. It is also possible to incorporate a reversibly thermochromic composition into the porous designs or patterns or into the non-discoloring layer to thereby enable the printed matter to undergo appearance changes with heat or cold besides the appearance changes with a medium.

Examples of the reversibly thermochromic composition include a reversibly thermochromic composition comprising the following three ingredients: (a) an electron-donating color-forming organic compound, (b) an electron-accepting compound, and (c) an organic compound medium which enables the color reactions between these two ingredients to take place reversibly. Examples thereof further include liquid crystals, Ag₂HgI₄, and Cu₂HgI₄.

Specific examples of the reversibly thermochromic composition comprising the three ingredients, i.e., an electron-donating color-forming organic compound, an electron-accepting compound, and an organic compound medium which enables color reactions to take place reversibly, are given in U.S. Pat. Nos. 4,028,118, 4,732,810, and 5,558,700. This composition changes in color at a given temperature (color change point). At ordinary temperature, the composition exists only in specific one of the two states respectively seen before and after the color change. Namely, the other state is maintained only during the period in which heat or cold required for the development of this state is kept being applied, and the composition returns to the original ordinary-temperature state upon removal of the heat or cold. This composition is of the type which changes in color so as to have a narrow hysteresis range (ΔH) with respect to color density change with temperature.

Also effective is the thermochromic color-memorizing composition proposed by the applicant which is disclosed in U.S. Pat. Nos. 4,720,301 and 5,558,699. This composition changes in color while showing enhanced hysteresis. Namely, plotting the color density against temperature gives a curve showing that the composition changes in color along routes which differ considerably between the case where the composition is heated from a temperature on the lower-temperature side of the color change temperature range and the reverse case where the composition is cooled from a temperature on the higher-temperature side of the color change temperature range. This type of composition is characterized in that the state obtained through a change at a temperature not higher than the lower color change point or not lower than the higher color change point can be memorized and retained in the ordinary-temperature range-between the lower color change point and the higher color change point.

The reversibly thermochromic composition comprising three ingredients, i.e., an electron-donating color-forming organic compound, an electron-accepting compound, and an organic compound medium which enables color reactions to take place reversibly, is effective even when applied as it is. However, the composition is preferably used after having been microencapsulated. This is because the reversibly thermochromic composition which has been microencapsulated can retain compositional uniformity and produce the same effect under various use conditions.

When microencapsulated, the reversibly thermochromic composition gives a pigment which is chemically and physically stable. The practical range of the particle diameter thereof is generally from 0.1 to 100 μm, preferably from 0.1 to 50 μm, more preferably from 0.1 to 30 μm.

For the microencapsulation, known techniques can be used. Examples thereof include interfacial polymerization, in-situ polymerization, in-liquid curing coating, phase separation from an aqueous solution, phase separation from an organic solvent, melt dispersion cooling, air-suspension coating, and spray drying. A suitable technique is selected according to applications. Before the microencapsulated composition is subjected to practical use, a secondary resin coating film may be further formed on the surface of the microcapsules to impart durability or modify the surface properties according to purposes.

In order for the water-discoloring printed matter to discolor, the porous designs or pattern should absorb water.

Examples of methods for adhering water to the water-discoloring printed matter include: a method comprising touching the printed matter with a finger wetted by water to allow it to absorb water; a method in which an applicator having bristles, a fibrous writing part, or the like at the tip or a brush is used; a method in which a container containing water and equipped with a fibrous part or brush for drawing water from the container is used for water application; a method in which a stamp having an open-cell or closed-cell foam fixed on the stamping side is used to adhere water; and a method in which a stamp having a plastic or rubber stamping surface which has been roughened is used to adhere water.

Especially preferred devices for the water-discoloring printed matter of the invention and the water-discoloring toy employing the same are: the applicator comprising a container containing water and equipped with a fibrous part or brush for drawing water from the container; the stamp having an open-cell or closed-cell foam fixed on the stamping side; and the stamp having a plastic or rubber stamping surface which has been roughened. In particular, when any of these devices is combined with the water-discoloring toy, a water-discoloring toy set highly suitable for practical use is obtained.

Specific examples of applications to which the water-discoloring printed matter of the invention, which is a printed matter obtained by forming the porous designs or patterns on an appropriate substrate, is usable include stuffed toys, dolls, garments for dolls, accessories for dolls, model cars and model ships, ornaments, training aids such as sheets for writing with water, garments such as dresses, swimsuits, and raincoats, boots and shoes such as rain shoes, printed matters such as waterproof books and calendars, playthings such as various game goods, swimming or diving goods such as wet suits, tubes, and flutterboards, kitchen utensils such as coasters and glasses, umbrellas, artificial flowers, and various indicators.

The invention will be explained below in more detail by reference to Examples, but the invention should not be construed as being limited to these Examples. In the following Examples, all parts are by weight.

### EXAMPLE 1

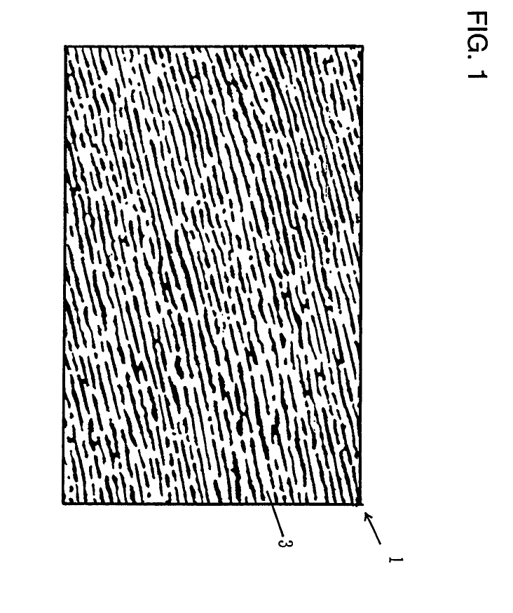

(See FIGS. 1 to 3)

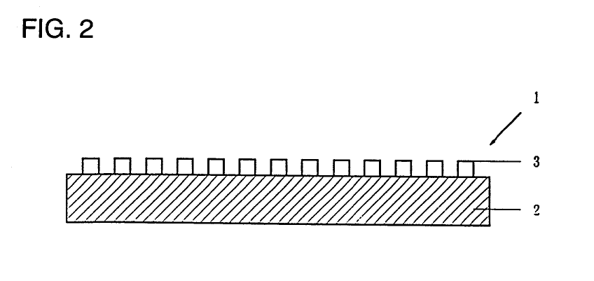

A white screen printing ink prepared by evenly mixing, with stirring, 15 parts of wet-process finely particulate silica [trade name, Nipsil E-200; manufactured by Nippon Silica Industrial Co., Ltd.], 30 parts of a urethane emulsion [trade name, Hydran HW-930; manufactured by Dainippon Ink & Chemicals, Inc.; solid content, 50%], 50 parts of water, 0.5 parts of a silicone antifoamer, 3 parts of a thickener for water-based inks, 1 part of ethylene glycol, and 3 parts of a blocked isocyanate crosslinking agent was used to print a geometrical denim pattern on the whole surface of a blue tricot fabric made of 50-D polyester yarns as a substrate 2 with a 100-mesh screen printing plate. The fabric was dried at 130° C. for 5 minutes to cure the ink and thereby form porous patterns 3. Thus, a water-discoloring printed matter 1 was obtained (see FIGS. 1 and 2).

The ratio of the area of the parts coated with the porous patterns to that of the parts not coated with the porous patterns was 65:35 per cm².

When the water-discoloring printed matter 1 was in a dry state, the blue color of the substrate 2 and the geometrical denim pattern (porous patterns 3) were seen. It was hence a colorful printed matter having excellent decorative properties.

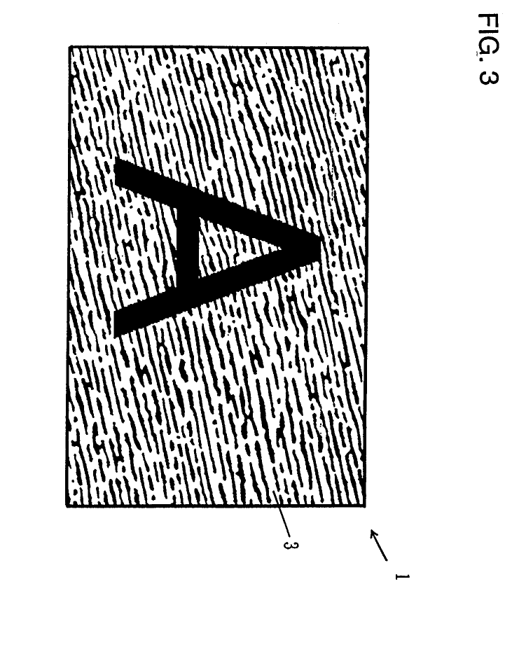

Subsequently, a character was drawn on the water-discoloring printed matter 1 with a marking pen containing water, upon which drawing the character parts of the porous patterns absorbed water and became transparent. As a result, the blue color of the substrate 2 came to be seen and, hence, a blue character appeared (see FIG. 3).

The character was retained when the porous patterns 3 were in an undried state. Upon drying, the printed matter 1 recovered the original geometrical denim pattern. These appearance changes could be caused repeatedly.

### EXAMPLE 2

A blue screen printing ink prepared by evenly mixing, with stirring, 5 parts of a blue pigment [trade name, Sandye Super Blue GLL; manufactured by Sanyo Color Works, Ltd.], 50 parts of an acrylic ester emulsion [trade name, Mowilith 763; manufactured by Hoechst Gosei K. K.; solid content, 48%], 3 parts of a thickener for water-based inks, 0.5 parts of a leveling agent, 0.3 parts of an antifoamer, and 5 parts of an epoxy crosslinking agent was used to conduct solid printing on the whole surface of a white tricot fabric made of 50-D polyester yarns as a substrate with a 180-mesh screen printing plate. The fabric was dried at 100° C. for 3 minutes to cure the ink and thereby form a colored layer.

Subsequently, a screen printing ink prepared by evenly mixing, with stirring, 15 parts of wet-process finely particulate silica [trade name, Nipsil E-220; manufactured by Nippon Silica Industrial Co., Ltd.], 45 parts of a urethane emulsion [trade name, Hydran AP-20; manufactured by Dainippon Ink & Chemicals, Inc.; solid content, 30%], 40 parts of water, 0.5 parts of a silicone antifoamer, 3 parts of a thickener for water-based inks, 1 part of ethylene glycol, and 3 parts of a blocked isocyanate crosslinking agent was used to print a geometrical denim pattern on the whole surface of the colored layer with a 100-mesh screen printing plate. The fabric was dried at 130° C. for 5 minutes to cure the ink and thereby form porous patterns. Thus, a water-discoloring printed matter was obtained.

The ratio of the area of the parts coated with the porous patterns to that of the parts not coated with the porous patterns was 65:35 per cm².

When the water-discoloring printed matter was in a dry state, the blue color of the colored layer and the geometrical denim pattern (porous patterns) were seen. It was hence a colorful printed matter having excellent decorative properties.

The water-discoloring printed matter was sewed to produce a garment for dolls, and the garment was put on a doll. Subsequently, a character was drawn on the garment with a marking pen having at the tip a fibrous writing part soaked with water. Upon this drawing, the character parts of the porous patterns absorbed water and became transparent. As a result, the blue color of the colored layer came to be seen and, hence, a blue character appeared.

The character was retained when the porous patterns were in an undried state. Upon drying, the printed matter recovered the original geometrical denim pattern. These appearance changes could be caused repeatedly.

### EXAMPLE 3

A brown screen printing ink prepared by evenly mixing, with stirring, 5 parts of a brown pigment [trade name, T C Brown F D; manufactured by Dainichiseika Color & Chemicals Mfg. Co., Ltd.], 50 parts of an acrylic ester emulsion [trade name, Mowilith 763; manufactured by Hoechst Gosei K. K.; solid content, 48%], 3 parts of a thickener for water-based inks, 0.5 parts of a leveling agent, 0.3 parts of an antifoamer, and 5 parts of an epoxy crosslinking agent was used to conduct solid printing on the whole surface of a white nylon taffeta fabric as a substrate with a 180-mesh screen printing plate. The fabric was dried at 100° C. for 3 minutes to cure the ink and thereby form a colored layer.

Subsequently, a screen printing ink prepared by evenly mixing, with stirring, 15 parts of wet-process finely particulate silica [trade name, Nipsil E-220; manufactured by Nippon Silica Industrial Co., Ltd.], 45 parts of a urethane emulsion [trade name, Hydran AP-20; manufactured by Dainippon Ink & Chemicals, Inc.; solid content, 30%], 40 parts of water, 0.5 parts of a silicone antifoamer, 3 parts of a thickener for water-based inks, 1 part of ethylene glycol, and 3 parts of a blocked isocyanate crosslinking agent was used to print dot designs made up of circles having a diameter of 2 mm arranged apart from one another on the whole surface of the colored layer with a 100-mesh screen printing plate. The fabric was dried at 130° C. for 5 minutes to cure the ink and thereby form porous designs. Thus, a water-discoloring printed matter was obtained.

The ratio of the area of the parts coated with the porous designs to that of the parts not coated with the porous designs was 50:50 per cm².

When the water-discoloring printed matter was in a dry state, the brown color of the colored layer and the dot designs (porous designs) were seen. It was hence a colorful printed matter having excellent decorative properties.

The water-discoloring printed matter was sewed to produce a teddy bear. Subsequently, a character was drawn thereon with a marking pen containing water, upon which drawing the character parts of the porous patterns absorbed water and became transparent. As a result, the brown color of the colored layer came to be seen and, hence, a brown character appeared.

The character was retained when the porous designs were in an undried state. Upon drying, the printed matter recovered the original dot pattern. These appearance changes could be caused repeatedly.

### EXAMPLE 4

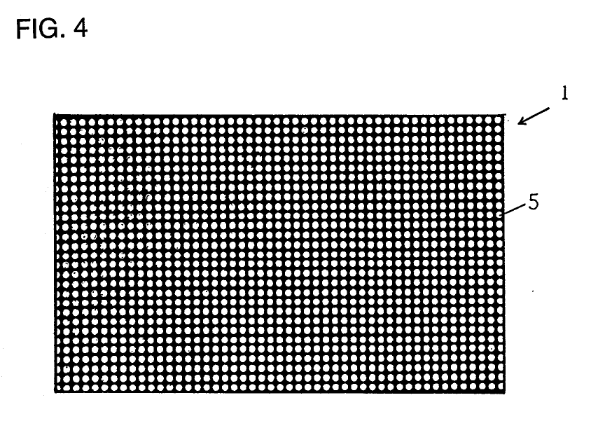

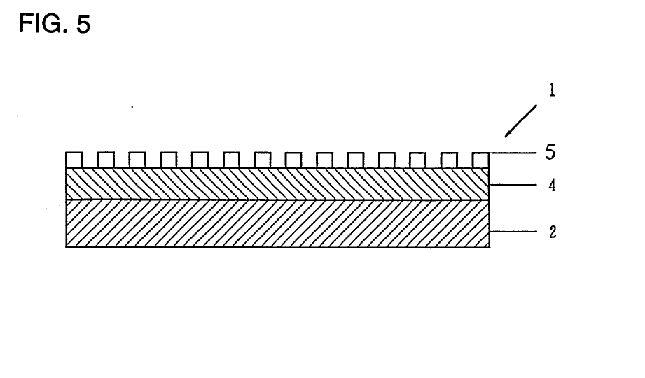

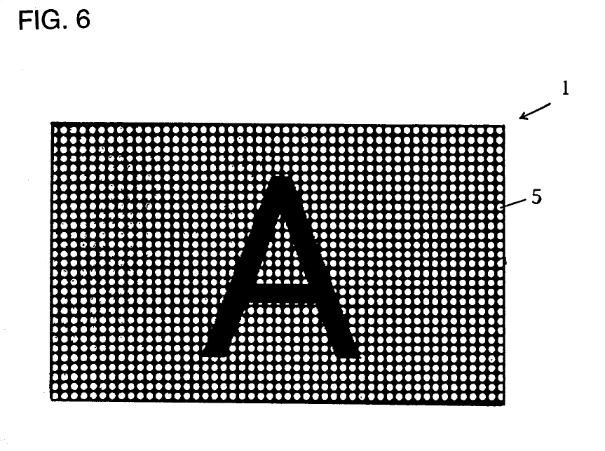

(See FIGS. 4 to 6)

A black screen printing ink prepared by evenly mixing, with stirring, 5 parts of a black pigment [trade name, Sandye Super Black; manufactured by Sanyo Color Works, Ltd.], 50 parts of an acrylic ester emulsion [trade name, Mowilith 763; manufactured by Hoechst Gosei K. K.; solid content, 48%], 3 parts of a thickener for water-based inks, 0.5 parts of a leveling agent, 0.3 parts of an antifoamer, and 5 parts of an epoxy crosslinking agent was used to conduct solid printing on the whole surface of a white synthetic paper (thickness, 80 μm) as a substrate 2 with a 180-mesh screen printing plate. The fabric was dried at 100° C. for 3 minutes to cure the ink and thereby form a colored layer 4.

Subsequently, a screen printing ink prepared by evenly mixing, with stirring, 15 parts of wet-process finely particulate silica [trade name, Nipsil E-220; manufactured by Nippon Silica Industrial Co., Ltd.], 45 parts of a urethane emulsion [trade name, Hydran AP-20; manufactured by Dainippon Ink & Chemicals, Inc.; solid content, 30%], 40 parts of water, 0.5 parts of a silicone antifoamer, 3 parts of a thickener for water-based inks, 1 part of ethylene glycol, and 3 parts of a blocked isocyanate crosslinking agent was used to print dot designs made up of circles having a diameter of 3 mm arranged apart from one another on the whole surface of the colored layer with a 100-mesh screen printing plate. The substrate was dried at 130° C. for 5 minutes to cure the ink and thereby form porous designs 5. Thus, a water-discoloring printed matter 1 was obtained.

The ratio of the area of the parts coated with the porous designs to that of the parts not coated with the porous designs was 35:65 per cm².

When the water-discoloring printed matter 1 was in a dry state, the black color of the colored layer and the dot designs (porous designs 5) were seen. It was hence a colorful printed matter having excellent decorative properties.

A character was drawn on the water-discoloring printed matter 1 with a writing brush soaked with water, upon which drawing the character parts of the porous designs absorbed water and became transparent. As a result, the black color of the colored layer came to be seen and, hence, a black character appeared.

The character was retained when the porous designs were in an undried state. Upon drying, the printed matter recovered the original dot pattern. These appearance changes could be caused repeatedly.

### EXAMPLE 5

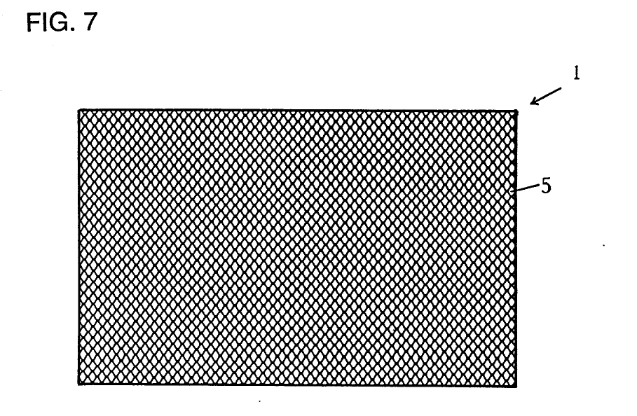

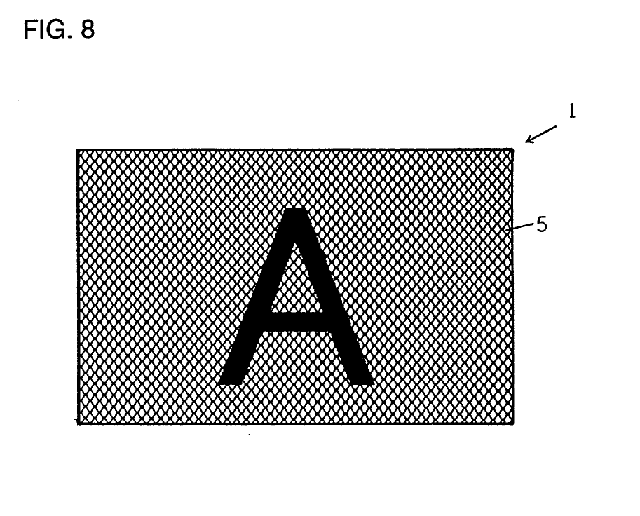

(See FIGS. 7 and 8)

A screen printing ink prepared by evenly mixing, with stirring, 15 parts of wet-process finely particulate silica [trade name, Nipsil E-220; manufactured by Nippon Silica Industrial Co., Ltd.], 45 parts of a urethane emulsion [trade name, Hydran A P-20; manufactured by Dainippon Ink & Chemicals, Inc.; solid content, 30%], 40 parts of water, 0.5 parts of a silicone antifoamer, 3 parts of a thickener for water-based inks, 1 part of ethylene glycol, and 3 parts of a blocked isocyanate crosslinking agent was used to print scale designs on the whole surface of a green tricot fabric made of 50-D polyester yarns as a substrate 2 with a 100-mesh screen printing plate. The fabric was dried at 130° C. for 5 minutes to cure the ink and thereby form porous designs 5. Thus, a water-discoloring printed matter 1 was obtained.

The ratio of the area of the parts coated with the porous designs to that of the parts not coated with the porous designs was 90:10 per cm².

When the water-discoloring printed matter 1 was in a dry state, the green color of the substrate and the scale designs (porous designs 5) were seen. It was hence a colorful printed matter having excellent decorative properties.

A stamp having water adherent to the stamping side was pressed against the water-discoloring printed matter 1, upon which stamping the stamped parts of the porous designs absorbed water and became transparent. As a result, the green color of the substrate 2 came to be seen and, hence, a green character appeared.

The character was retained when the porous designs were in an undried state. Upon drying, the printed matter 1 recovered the original scale designs. These appearance changes could be caused repeatedly.

### EXAMPLE 6

A yellow screen printing ink prepared by evenly mixing, with stirring, 5 parts of a yellow pigment [trade name, Sandye Super Yellow H10G; manufactured by Sanyo Color Works, Ltd.], 50 parts of an acrylic ester emulsion [trade name, Mowilith 763; manufactured by Hoechst Gosei K. K.; solid content, 48%], 3 parts of a thickener for water-based inks, 0.5 parts of a leveling agent, 0.3 parts of an antifoamer, and 5 parts of an epoxy crosslinking agent was used to conduct solid printing on the whole surface of a white tricot fabric made of 50-D polyester yarns as a substrate with a 180-mesh screen printing plate. The fabric was dried at 100° C. for 3 minutes to cure the ink and thereby form a colored layer.

Subsequently, a screen printing ink prepared by evenly mixing, with stirring, 15 parts of wet-process finely particulate silica [trade name, Nipsil E-220; manufactured by Nippon Silica Industrial Co., Ltd.], 1 part of a blue pigment [trade name, Sandye Super Blue GLL; manufactured by Sanyo Color Works, Ltd.], 45 parts of a urethane emulsion [trade name, Hydran AP-20; manufactured by Dainippon Ink & Chemicals, Inc.; solid content, 30%], 40 parts of water, 0.5 parts of a silicone antifoamer, 3 parts of a thickener for water-based inks, 1 part of ethylene glycol, and 3 parts of a blocked isocyanate crosslinking agent was used to print a checker pattern on the whole surface of the colored layer 4 with a 100-mesh screen printing plate. The fabric was dried at 130° C. for 5 minutes to cure the ink and thereby form light-blue porous patterns. Thus, a water-discoloring printed matter was obtained.

The ratio of the area of the parts coated with the porous patterns to that of the parts not coated with the porous patterns was 70:30 per cm².

When the water-discoloring printed matter was in a dry state, the yellow color of the colored layer and the light-blue checker pattern (porous patterns) were seen. It was hence a colorful printed matter having excellent decorative properties.

The water-discoloring fabric sheet was sewed to produce a garment for dolls, and the garment was put on a doll. Subsequently, a character was drawn on the garment with a marking pen having at the tip a fibrous writing part soaked with water. Upon this drawing, the character parts of the porous patterns absorbed water and became transparent. As a result, the transparent blue color of the porous patterns mixed with the yellow color of the colored layer and, hence, a green character appeared.

The character was retained when the porous patterns were in an undried state. Upon drying, the printed matter recovered the original checker pattern. These appearance changes could be caused repeatedly.

### EXAMPLE 7

A blue screen printing ink prepared by evenly mixing, with stirring, 5 parts of a blue pigment [trade name, Sandye Super Blue GLL; manufactured by Sanyo Color Works, Ltd.], 50 parts of an acrylic ester emulsion [trade name, Mowilith 763; manufactured by Hoechst Gosei K. K.; solid content, 48%], 3 parts of a thickener for water-based inks, 0.5 parts of a leveling agent, 0.3 parts of an antifoamer, and 5 parts of an epoxy crosslinking agent was used to conduct solid printing on the whole surface of a white plain-stitch polyester fabric having stretchability as a substrate with a 180-mesh screen printing plate. The fabric was dried at 100° C. for 3 minutes to cure the ink and thereby form a colored layer.

Subsequently, a screen printing ink prepared by evenly mixing, with stirring, 15 parts of wet-process finely particulate silica [trade name, Nipsil E-220; manufactured by Nippon Silica Industrial Co., Ltd.], 45 parts of a urethane emulsion [trade name, Hydran AP-20; manufactured by Dainippon Ink & Chemicals, Inc.; solid content, 30%], 40 parts of water, 0.5 parts of a silicone antifoamer, 3 parts of a thickener for water-based inks, 1 part of ethylene glycol, and 3 parts of a blocked isocyanate crosslinking agent was used to print a geometrical denim pattern on the whole surface of the colored layer with a 100-mesh screen printing plate. The fabric was dried at 130° C. for 5 minutes to cure the ink and thereby form porous patterns. Thus, a water-discoloring printed matter was obtained.

The ratio of the area of the parts coated with the porous patterns to that of the parts not coated with the porous patterns was 65:35 per cm².

When the water-discoloring printed matter was in a dry state, the blue color of the colored layer and the geometrical denim pattern (porous patterns) were seen. It was hence a colorful printed matter having excellent decorative properties and stretchability and giving an excellent feeling.

The printed matter was cut and sewed to produce a stuffed toy dog employing the printed matter as the skin. Thus, a water-discoloring toy was obtained.

Circles were drawn on the toy with a marking pen having at the tip a fibrous writing part soaked with water. Upon this drawing, the circle parts of the porous patterns absorbed water and became transparent. As a result, the blue color of the colored layer came to be seen and, hence, circles appeared.

The circles were retained when the porous patterns were in an undried state. Upon drying, the toy recovered the original geometrical denim pattern. These appearance changes could be caused repeatedly.

The stuffed toy gave an excellent feeling like the printed matter. The skin had well conformed to the local elongation which had occurred during the toy production. Thus, a stuffed toy product having a good appearance could be produced.

The invention can provide a water-discoloring printed matter which in a dry state has a complicated, colorful, highly decorative appearance and in which the porous designs or patterns undergo satisfactory color changes depending on the state of being wetted by water. The printed matter is highly suitable for use in applications in the fields of various decorations, toys, clothing, etc.

Especially when a fabric is used as the substrate, the printed matter is suitable for use in toys such as doll garments and stuffed toys. Water-discoloring toys excellent in decorative properties and flexibility can be provided.

While the invention has been described in detail and with reference to specific embodiments thereof, it will be apparent to one skilled in the art that various changes and modifications can be made therein without departing from the scope thereof.

This application is based on Japanese patent applications No. 2001-115343 filed Apr. 13, 2001 and No. 2002-053651 filed Feb. 28, 2002, the entire contents thereof being hereby incorporated by reference.

What is claimed is:

1. A water-discoloring printed matter which comprises (1) a substrate and (2) closely-formed porous designs or patterns fixed on a surface of said substrate,
said porous designs or patterns comprising a binder resin and a low-refractive-index pigment dispersed therein.

2. The water-discoloring printed matter according to claim 1, wherein the porous designs or patterns are independent from one another.

3. The water-discoloring printed matter according to claim 1, wherein the porous designs or patterns are partly in contact with one another.

4. The water-discoloring printed matter according to claim 2, wherein the porous designs or patterns are linear.

5. The water-discoloring printed matter according to claim 3, wherein the porous designs or patterns are linear.

6. The water-discoloring printed matter according to claim 4 or 5, wherein the porous patterns are selected from the group consisting of lattice patterns, net patterns, and knit patterns.

7. The water-discoloring printed matter according to claim 1, wherein the ratio of the area of the parts coated with the porous designs or patterns to the area of the parts not coated with the porous designs or patterns is from 30:70 to 95:5 per cm².

8. The water-discoloring printed matter according to claim 1, wherein the substrate is a fabric.

9. The water-discoloring printed matter according to claim 8, wherein the fabric is a stretchable knitted fabric.

10. A water-discoloring toy which is in the form of a garment for dolls or of a stuffed toy and has been produced by sewing the printed matter of claim 8 or 9.
